(19) United States
(12) Patent Application Publication
(10) Pub. No.: US 2021/0377092 A1
(43) Pub. Date: Dec. 2, 2021

(54) UPLINK PAPR REDUCTION WITH CONTROLLED EVM FOR FREQUENCY DIVISION MULTIPLEXING IN OFDM

(71) Applicant: QUALCOMM Incorporated, San Diego, CA (US)

(72) Inventors: Noam ZACH, Kiryat Ono (IL); Guy WOLF, Rosh Haayin (IL); Ory EGER, Tel Aviv (IL); Sharon LEVY, Binyamina (IL); Assaf TOUBOUL, Netanya (IL)

(21) Appl. No.: 16/888,090

(22) Filed: May 29, 2020

(51) Int. Cl. H04L 27/26; H04W 72/04; H04W 76/27; H04L 1/00

(52) U.S. Cl. CPC H04L 27/2623; H04W 72/0413; H04L 1/0003; H04W 72/042; H04W 72/0453; H04W 76/27

(57) ABSTRACT

A user equipment (UE) may reduce a peak to average power ratio (PAPR) ratio for an uplink transmission. The UE may receive an indication of an allowed error vector magnitude (EVM) for each of an uplink data signal, an uplink reference signal, and an uplink control signal from a base station. The base station may determine the allowed EVM based on a signal to noise ratio (SNR) for the UE measured at the base station. The UE may generate one or more uplink signals. The UE may apply a PAPR reduction to the one or more uplink signals based on the allowed EVM corresponding to each of the one or more uplink signals. The UE may transmit the one or more uplink signals to the base station.

### BACKGROUND

### Technical Field

The present disclosure relates generally to communication systems, and more particularly, to uplink peak to average power (PAPR) reduction with controlled error vector magnitude (EVM) for frequency division multiplexing (FDM) in orthogonal frequency division multiplexing (OFDM).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure provides a method of wireless communication for a user equipment (UE). The method may include receiving an indication of an allowed error vector magnitude (EVM) for each of an uplink data signal, an uplink reference signal, and an uplink control signal from a base station. The method may include generating one or more uplink signals. The method may include applying a peak to average power ratio (PAPR) reduction to the one or more uplink signals based on the allowed EVM corresponding to each of the one or more uplink signals generate a reduced PAPR uplink signal. The method may include transmitting the reduced PAPR uplink signal to the base station.

The disclosure also provides an apparatus (e.g., a UE) including a memory storing computer-executable instructions and at least one processor configured to execute the computer-executable instructions to perform the above method, an apparatus including means for performing the above method, and anon-transitory computer-readable medium storing computer-executable instructions for performing the above method.

In an aspect, the disclosure provides a method of wireless communication for a base station. The method may include measuring an uplink signal to noise ratio (SNR) of a UE. The method may include determining, for the UE, an allowed EVM for each of an uplink data signal, an uplink reference signal, and an uplink control signal based on the SNR. The method may include transmitting an indication of the allowed EVM for each of the uplink data signal, the uplink reference signal, and the uplink control signal for the UE. The method may include receiving one or more uplink signals complying with the allowed EVM. The method may include decoding the one or more uplink signals.

The disclosure also provides an apparatus (e.g., a base station) including a memory storing computer-executable instructions and at least one processor configured to execute the computer-executable instructions to perform the above method, an apparatus including means for performing the above method, and a computer-readable medium storing computer-executable instructions for performing the above method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first 5G/NR frame.

FIG. 2B is a diagram illustrating an example of DL channels within a 5G/NR subframe.

FIG. 2C is a diagram illustrating an example of a second 5G/NR frame.

FIG. 2D is a diagram illustrating an example of a 5G/NR subframe.

FIG. 3 is a diagram illustrating an example of a base station and user equipment (UE) in an access network.

FIGS. 4A and 4B are diagrams illustrating example power amplifier operation based on peak to average power ratio (PAPR).

FIG. 5 is a diagram illustrating an example operation for applying PAPR reduction to a multiplexed signal.

FIG. 6 is a diagram illustrating example communications and components of a base station and a UE.

FIG. 7 is a conceptual data flow diagram illustrating the data flow between different means/components in an example transmitting device.

FIG. 8 is a conceptual data flow diagram illustrating the data flow between different means/components in an example receiving device.

FIG. 9 is a flowchart of an example of a method of wireless communication for a user equipment (UE).

FIG. 10 is a flowchart of an example of a method of applying a PAPR reduction.

FIG. 11 is a flowchart of an example of a method of wireless communication for a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Power consumption is a concern for wireless devices including both base stations and user equipment (UE). Although a base station may have a constant power supply, power consumption may be a significant cost for a network operator. Orthogonal frequency division multiple access (OFDMA) has many advantages such as enabling simple channel estimation at the receiver, flexibility in utilizing the available time/frequency resources, etc. However, OFDMA may have an increased peak to average power ratio (PAPR) compared to single carrier techniques. Higher order modulation schemes such as 256 QAM, 1024 QAM, or even 16KQAM may increase throughput but require error vector magnitude (EVM) performance that may further increase power consumption. EVM may be a measure of distortion of a signal prior to transmission. As such, EVM may be expressed in units of decibels (dB) with a negative direction. In some cases, the direction of the EVM may not be written, but may be assumed. Accordingly, good EVM performance may refer to a lower amount of EVM.

A power amplifier may be most efficient when a working point is close to a non-linear part of a power output curve. When PAPR is high, the power amplifier may need a large backoff to operate effectively. With a lower PAPR, the power amplifier may use a lower backoff and operate in a more efficient region. Accordingly, reducing PAPR may reduce power consumption by improving efficiency of a power amplifier. Example PAPR reduction techniques may include tone reservation, crest factor reduction (CFR), active constellation extension (ACE), or peak suppression with information message (PSIM). Tone reservation may be lossless, whereas CFR and ACE may be lossy (e.g., increased EVM). PSIM may be configurable with a tradeoff between bandwidth and loss.

EVM performance requirements may depend on channel conditions and the modulation scheme of the signal. For example, higher order modulation schemes may require better EVM performance, whereas control signals using lower order modulation schemes may be successfully received with greater EVM. Similarly, reference signals may require a low EVM in order to achieve good channel estimation. In the uplink (UL) direction, a UE may transmit frequency division multiplexed (FDM) signals of different types. Applying a PAPR reduction technique uniformly to all of the multiplexed signals may result in an EVM that is too high for some signals or a PAPR that is unnecessarily high. Generally, when data, reference signals, and control channels are multiplexed, the lossy PAPR reduction schemes consider the strictest EVM requirement among all signals as the EVM limit target of the PAPR reduction scheme. Accordingly, the amount of PAPR reduction may be limited.

In an aspect, the present disclosure provides techniques for a network to signal each UE an allowed transmission EVM level for each signal. In particular, the EVM level for each signal may include a data EVM, a control EVM, and a reference signal EVM. The UE may use the allowed transmission EVM level for each signal to perform uplink PAPR reduction. For instance, the UE may perform greater PAPR reduction on signals that can tolerate a greater EVM. Accordingly, the UE may further reduce overall PAPR compared to applying a single EVM limit to all signals.

In an aspect, the network may determine the allowed transmission EVM level based on a signal to noise ratio (SNR) measured at a base station. The base station may determine, for each signal, a level of transmission EVM that would still allow the base station to correctly receive the signal with an acceptable error rate. The base station may generate an EVM indication including the allowed transmission EVM level for each signal. For example, the EVM indication may include data EVM, a control EVM, and a reference signal EVM. The base station may transmit the EVM indication as either a radio resource control (RRC) message or a downlink control information (DCI). The base station may receive the uplink transmission complying with the allowed transmission EVM level for each signal. Accordingly, the base station may decode the uplink transmission. In some cases, the base station may decode the uplink transmission based on a PAPR reduction technique (e.g., PSIM).

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

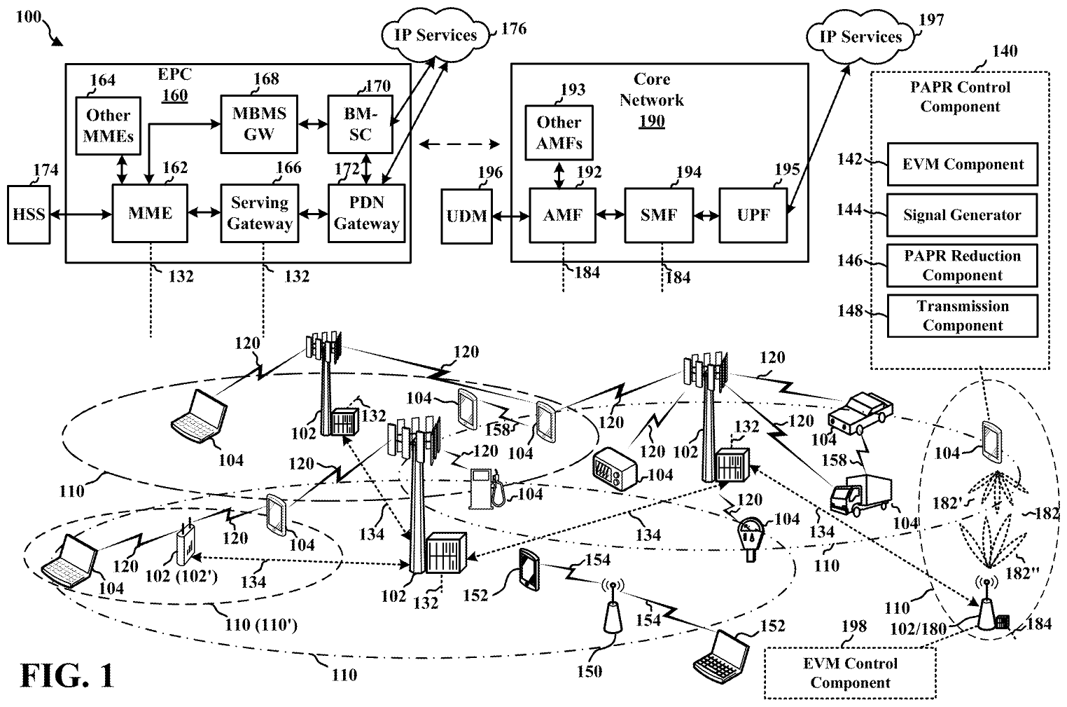

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In an aspect, as illustrated, one or more of the UEs 104 may include a PAPR control component 140 that receives an indication of an allowed EVM and applies a PAPR reduction to one or more uplink signals based on the allowed EVM to transmit the uplink signals with reduced power consumption. The PAPR control component 140 may include an allowed EVM component 142 that receives an indication of the allowed EVM for each of an uplink data signal, an uplink reference signal, and an uplink control signal from a base station; a signal generator 144 that generates one or more uplink signals; a PAPR reduction component 146 that applies a PAPR reduction to the one or more uplink signals based on the allowed EVM corresponding to each of the one or more uplink signals; and a transmission component 148 that transmits the one or more uplink signals to the base station 102.

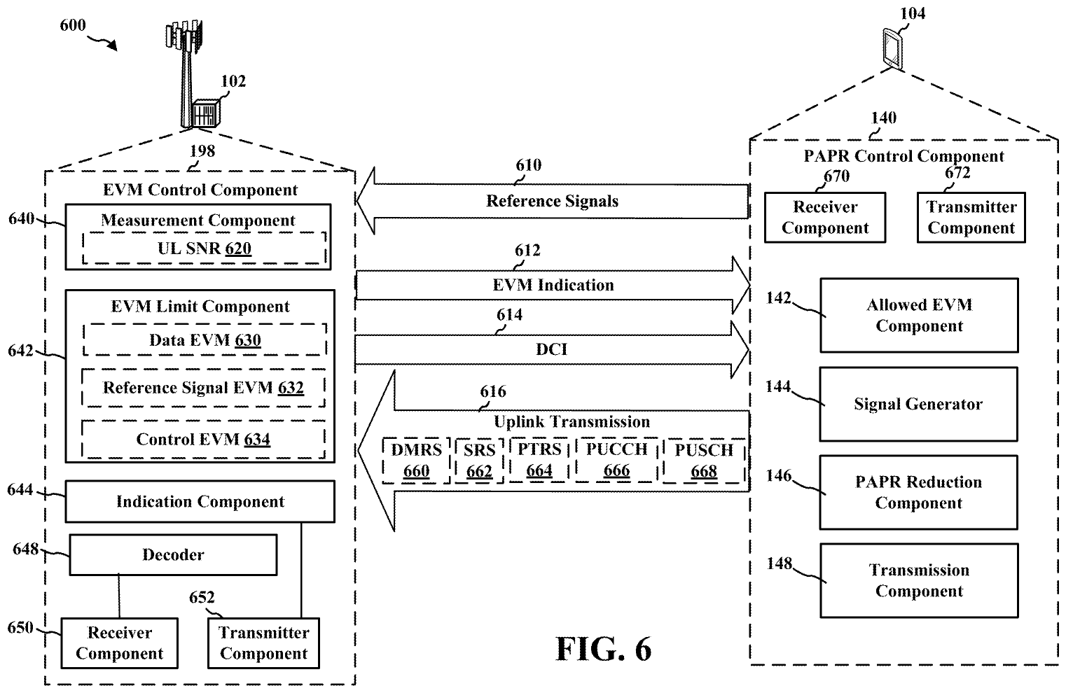

In an aspect, as illustrated, one or more of the base stations 102 may include an EVM control component 198 that controls an EVM of signals transmitted from a UE. As illustrated in further detail in FIG. 6, the EVM control component 198 may include a measurement component 640 that measures an uplink SNR of a UE 104 at the base station 102; an EVM limit component 642 that determines, for the UE 104, the allowed EVM for each of an uplink data signal, an uplink reference signal, and an uplink control signal based on the SNR; an indication component 644 that transmits, from the base station 102, an indication of the allowed EVM for each of the uplink data signal, the uplink reference signal, and the uplink control signal for the UE 104; a receiver component 650 that receives one or more uplink signals complying with the allowed EVM; and a decoder 648 that decodes the one or more uplink signals.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

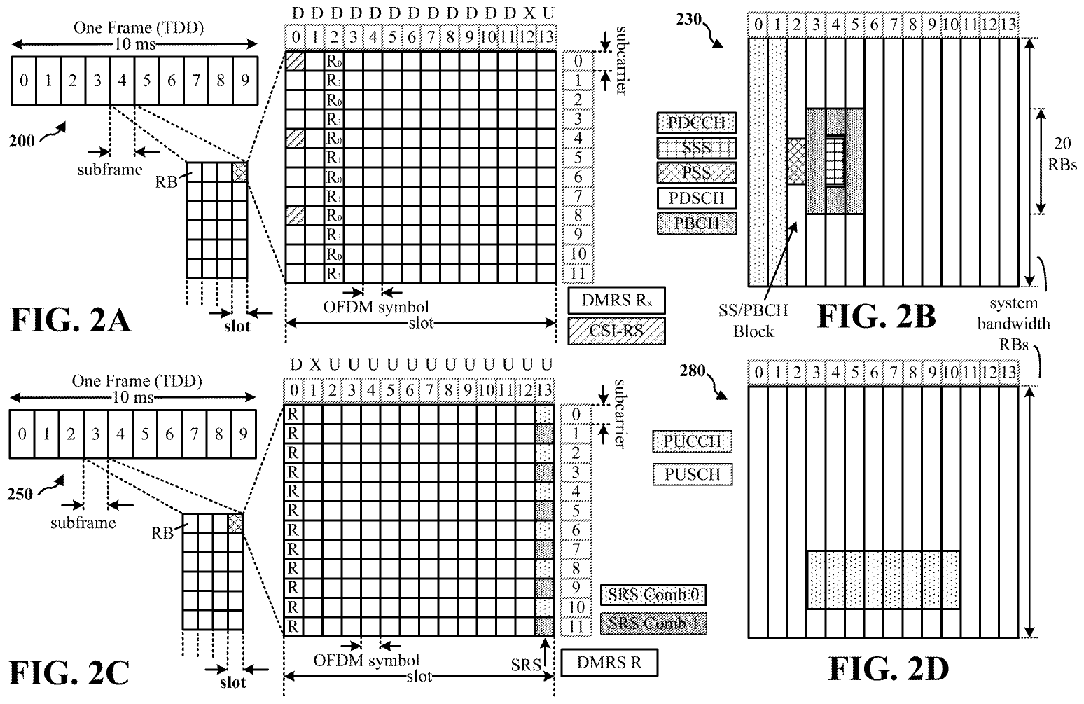

FIG. 2A is a diagram 200 illustrating an example of a first subframe within a 5G/NR frame structure. FIG. 2B is a diagram 230 illustrating an example of downlink (DL) channels within a 5G/NR subframe. FIG. 2C is a diagram 250 illustrating an example of a second subframe within a 5G/NR frame structure. FIG. 2D is a diagram 280 illustrating an example of uplink (UL) channels within a 5G/NR subframe. The 5G/NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

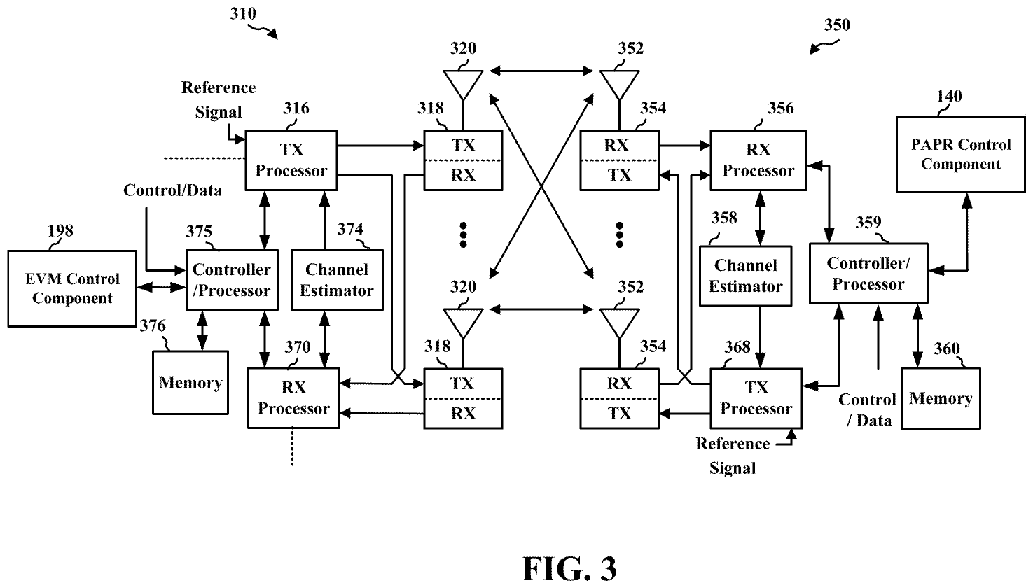

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the PAPR control component 140 of FIG. 1.

At least one of the TX processor 316, the RX processor 370, and the controller/processor 375 may be configured to perform aspects in connection with the EVM control component 198 of FIG. 1.

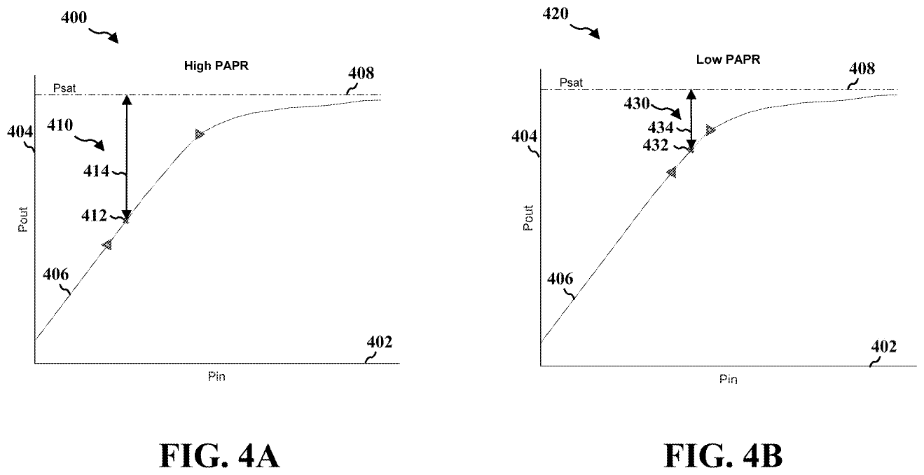

FIG. 4A is a diagram 400 of operation of a power amplifier. The power amplifier may receive a power in (Pin) 402 and produce a power out (Pout) 404 according to a curve 406. The power amplifier may have a power saturation (Psat) level 408 and the curve 406 may enter a non-linear portion as the curve 406 approaches the Psat level 408. The ratio of Pout to Pin is constant in a linear regime of the power amplifier and is decreased in the non-linear regime. For a signal with a high PAPR (e.g., greater than 6 dB), the power amplifier may operate over an operating range 410 including a working point 412 based on a backoff 414. In order to maximize the efficiency of the power amplifier (e.g., μ=Pout/Psupply), the working point 412 may be as close as possible to the non-linear part of the curve 406. Due to the high PAPR, a large backoff 414 may be taken to have good EVM for high constellations of high modulation schemes.

FIG. 4B is a diagram 420 of operation of the same power amplifier as FIG. 4A operating with a lower PAPR (e.g., less than 6 dB). The Pin 402, Pout 404, curve 406, and Psat level 408 may be the same as in FIG. 4A. Due to the lower PAPR, a backoff 434 may be smaller than the backoff 414. Accordingly, the operating range 430 may be smaller than the operating range 410 and the working point 432 may be set at a point with a greater power efficiency than shown in FIG. 4A. Accordingly, power consumption may be reduced without reaching the non-linear part of the curve and compromising EVM.

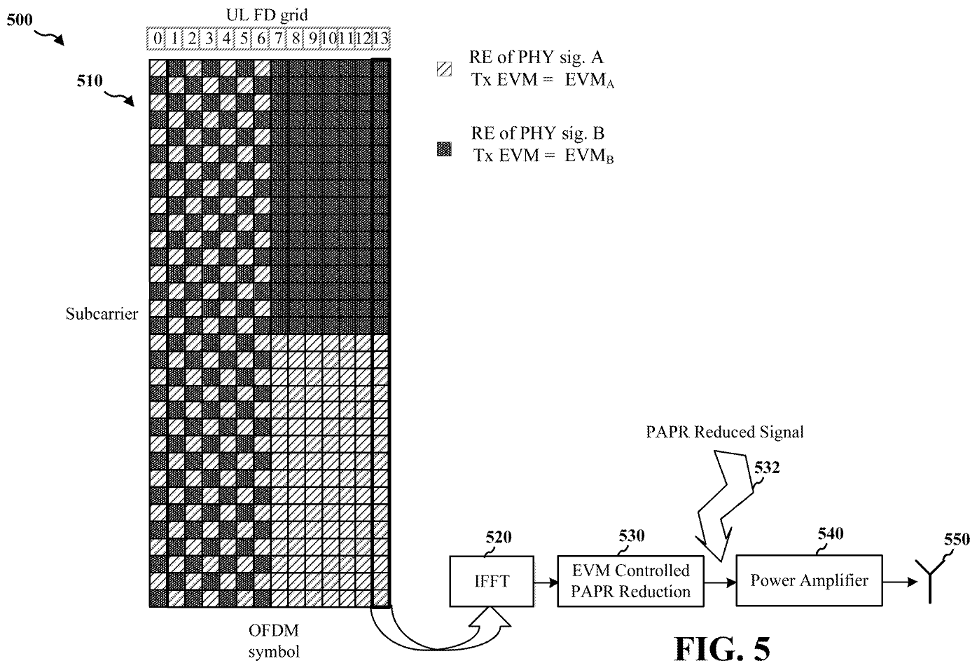

FIG. 5 is a diagram 500 illustrating application of PAPR reduction to a frequency domain multiplexed signal. In an aspect, the UE 104 including the PAPR control component 140 may apply PAPR reduction to a frequency domain multiplexed signal 510. By reducing the PAPR of a signal for transmission, the UE 104 may operate a power amplifier in a more efficient region and conserve battery power.

The signal 510 may be represented by a resource grid. Within each OFDM symbol period, the signal 510 may include resource elements (REs) assigned to a first physical (PHY) signal (A) and a second PHY signal (B). For illustrative purposes, the signal A and signal B are illustrated as interleaved in symbols 0-6 and assigned in blocks in symbols 7-13. Each PHY signal may be associated with a different allowed EVM. For example, PHY signal A is associated with EVM_{A} and PHY signal b is associated with EVM_{B}. The frequency domain multiplexed signal 510 may be transformed into a time domain signal via an inverse fast Fourier transform (IFFT) 520. The PAPR may be based on the time domain signal. For example, the time domain signal may include a series of quadrature (I/Q) samples, each associated with an amplitude. The amplitude of the highest peaks of the time domain signal relative to the average power of the signal may determine the PAPR.

The UE 104 may perform an EVM controlled PAPR reduction 530 to reduce the PAPR while satisfying the allowed EVM (e.g., EVM_{A} and EVM_{B}). Generally, PAPR reduction increases the EVM by distorting the signal. For example, known lossy PAPR reduction techniques such as crest factor reduction (CFR), active constellation extension (ACE), and peak suppression with information message (PSIM) may be configurable to reduce PAPR while complying with an allowed EVM. The present disclosure provides additional techniques for PAPR reduction with per subcarrier EVM control. The EVM controlled PAPR reduction 530 may produce a PAPR reduced signal 532. The PAPR reduced signal 532 may be provided to the power amplifier 540 for transmission via one or more antennas 550.

FIG. 6 is a diagram 600 illustrating example communications and components of a base station 102 and a UE 104. The UE 104 may include the PAPR control component 140. The base station 102 may include the EVM control component 198.

As discussed above regarding FIG. 1, the PAPR control component 140 may include the allowed EVM component 142, the signal generator 144, the PAPR reduction component 146, and the transmission component 148. The PAPR control component 140 may also include a receiver component 670 and a transmitter component 672. The receiver component 670 may include, for example, a radio frequency (RF) receiver for receiving the signals described herein. The transmitter component 672 may include for example, an RF transmitter for transmitting the signals described herein. In an aspect, the receiver component 670 and the transmitter component 672 may be co-located in a transceiver. The transmitter component 672 may include the power amplifier 540 and the antennas 550.

The EVM control component 198 may include the measurement component 640, the EVM limit component 642, the indication component 644, and the decoder 648. The EVM control component 198 may also include a receiver component 650 and a transmitter component 652. The receiver component 650 may include, for example, a RF receiver for receiving the signals described herein. The transmitter component 652 may include for example, an RF transmitter for transmitting the signals described herein. In an aspect, the receiver component 650 and the transmitter component 652 may be co-located in a transceiver.

The UE 104 and/or the PAPR control component 140 may transmit reference signals 610. In an aspect, the reference signals 610 may be transmitted without PAPR reduction. The measurement component 640 at the base station 102 may measure the reference signals 610 to determine an UL SNR 620. The UL SNR 620 may be a measure of signal quality that indicates how likely the base station 102 is to be able to correctly receive a signal. For example, the base station 102 may determine a modulation and coding scheme (MCS) for uplink signals based on the UL SNR 620. The EVM may similarly affect the ability of the base station 102 to receive signals.

The EVM limit component 642 may determine, for the UE 104, an allowed EVM for each of an uplink data signal, an uplink reference signal, and an uplink control signal based on the UL SNR 620. In particular, the EVM limit component 642 may determine a data EVM 630, a reference signal EVM 632, and a control EVM 634. For instance, the EVM limit component 642 may determine a difference between the UL SNR 620 for a respective signal and a required SNR for a MCS of the signal for a scheduled transmission. Based on estimated Rx SNR in a scheduled transmission, the EVM limit component 642 can determine the level of allowed EVM per PHY signal. This can be done based on MCS and off-line characteristics of the reception (including control information decoding, channel estimation, and data decoding). In some implementations, control signals may use a lower MCS to improve reliability while data signals may use a higher MCS to increase throughput. In an aspect, the EVM limit for a signal may be based on a difference between the UL SNR 620 and a SNR required to receive the signal at a particular MCS.

The indication component 644 may transmit an EVM indication 612 indicating the allowed EVM for each of the uplink data signal, the uplink reference signal, and the uplink control signal. For example, the EVM indication 612 may be a radio resource control (RRC) message including the data EVM 630, the reference signal EVM 632, and the control EVM 634. As another example, the EVM indication 612 may be included in a downlink control information (DCI) 614 that schedules a transmission. The indication component 644 may transmit the EVM indication 612 and/or the DCI 614 via the transmitter component 652.

The allowed EVM component 142 may receive and decode the EVM indication 612 to determine the allowed EVM for each of an uplink data signal, an uplink reference signal, and an uplink control signal. For example, the allowed EVM component 142 may extract the data EVM 630, the reference signal EVM 632, and the control EVM 634 from the EVM indication 612.

The signal generator 144 may generate one or more uplink signals. For example, the uplink signals may include a data signal based on buffered uplink data for a transmission that has been scheduled by the DCI 614. The signal generator 144 may also generate control signals to provide feedback to the base station 102 and reference signals, which may be used to decode the data signal. For example, the data signal may be a physical uplink shared channel (PUSCH), the control signal may be a physical uplink control channel (PUCCH), and the reference signals may include a demodulation reference signal (DMRS), sounding reference signal (SRS), and/or a phase tracking reference signal (PTRS). In an aspect, the signal generator 144 may generate a frequency domain multiplexed signal such as the signal 510 by assigning the generated uplink signals to specific resources (e.g., subcarriers and symbols).

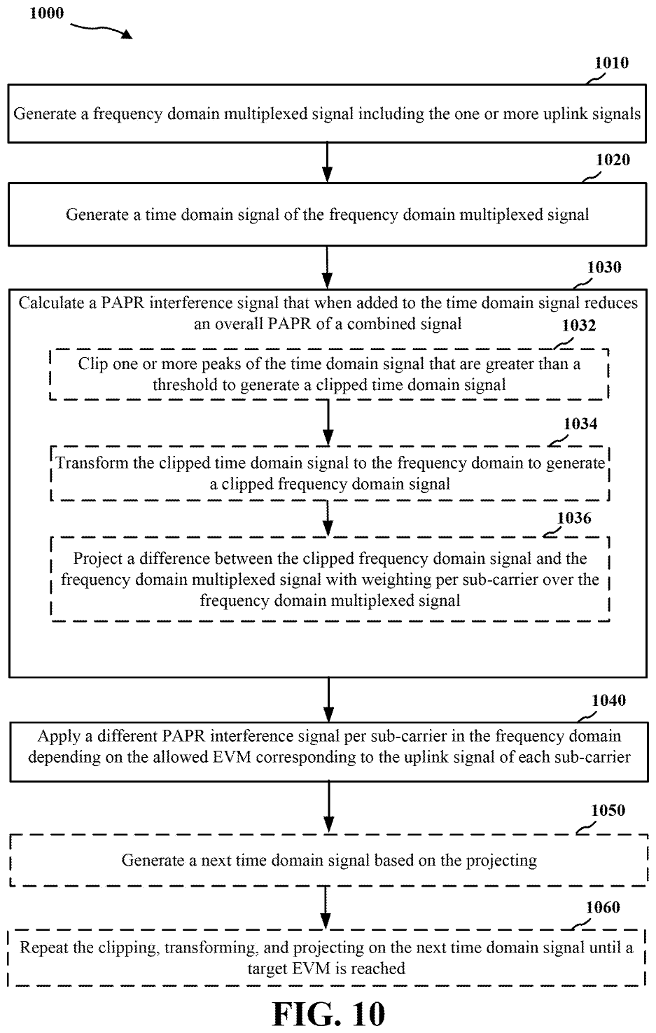

The PAPR reduction component 146 may perform the EVM controlled PAPR reduction 530 on the one or more uplink signals. The PAPR reduction component 146 may use the data EVM 630, the reference signal EVM 632, and the control EVM 634 to control the EVM for each of the one or more uplink signals. A detailed example technique for performing PAPR reduction with respect to allowed EVMs per subcarrier is discussed in detail below with respect to FIG. 10.

The transmission component 148 may transmit the one or more uplink signals to the base station 102. For example, the transmission component 148 may transmit the uplink transmission 616 including the one or more uplink signals.

The receiver component 650 of the base station 102 may receive the uplink transmission 616. The uplink transmission may comply with the allowed EVM. The decoder 648 may decode the one or more uplink signals of the uplink transmission 616. In an aspect, the decoder 648 may reconstruct an original signal according to a PAPR reduction technique. For example, where PSIM is used for PAPR reduction, the decoder 648 may reconstruct the original signal based on a PSIM control channel including clipped peak information.

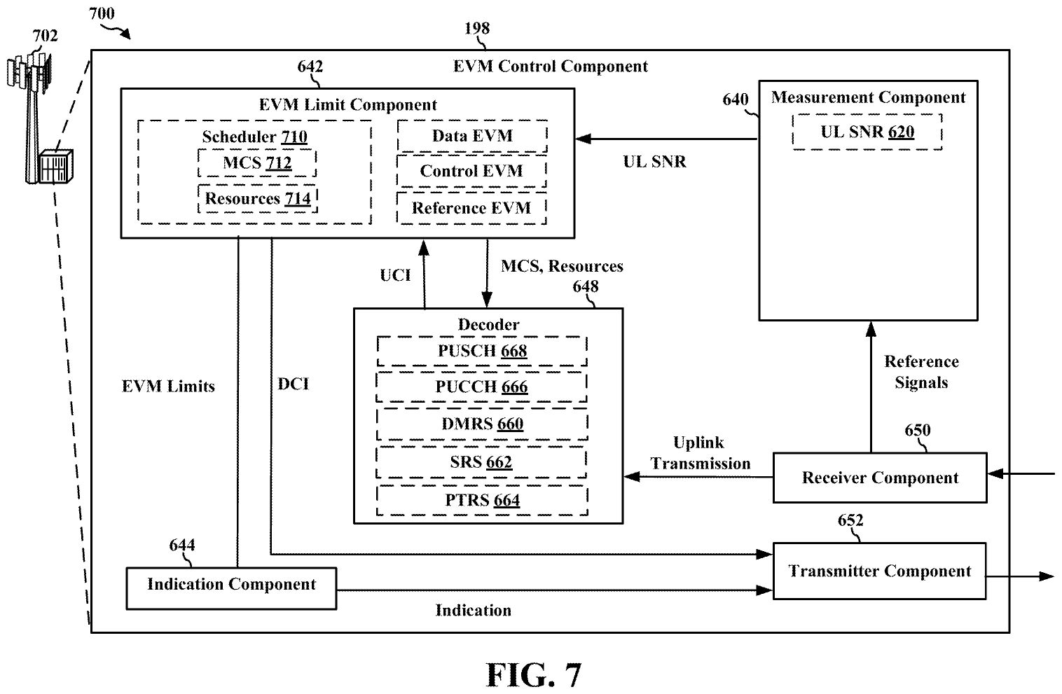

FIG. 7 is a conceptual data flow diagram 700 illustrating the data flow between different means/components in an example base station 702, which may be an example of the base station 102 including the EVM control component 198.

The receiver component 650 may receive uplink signals such as the reference signals 610 and the uplink transmission 616. The receiver component 650 may provide the reference signals 610 to the measurement component 640. The receiver component 650 may provide the uplink transmission 616 to the decoder 648.

The measurement component 640 may determine the UL SNR 620 based on the reference signals 610. For example, the measurement component 640 may compare the received reference signals 610 to known transmission sequences to determine the UL SNR 620. The measurement component 640 may provide the UL SNR 620 to the EVM limit component 642.

The EVM limit component 642 may receive the UL SNR 620 from the measurement component. The EVM limit component 642 may receive uplink control information (UCI) from the decoder 648. In an aspect, the EVM limit component 642 may include or communicate with a scheduler 710. The EVM limit component 642 may determine the EVM limits (e.g., the data EVM 630, the reference signal EVM 632, and the control EVM 634) in conjunction with a MCS 712 and resources 714. For example, where both MCS and EVM are dynamically indicated by the DCI 614, the scheduler 710 may determine an MCS 712 and resources 714 sufficient to carry an uplink data payload on PUSCH based on the UL SNR 620 and the UCI. The EVM limit component 642 may then determine the data EVM 630 based on the MCS 712 and the UL SNR 620. For example, the MCS 712 may be associated with a SNR associated with an acceptable block error rate (BLER). The EVM limit component 642 may determine the data EVM 630 based on a difference between the UL SNR 620 and the SNR associated with the MCS 712. In another aspect, where the EVM limit is at least semi-static (e.g., configured by RRC signaling), the EVM limit component 642 may determine the EVM limits based on an average SNR over a time period. The scheduler 710 may determine the MCS 712 and resources 714 based on a most recent UL SNR 620, the UCI, and the currently configured EVM limits. For instance, the EVM limit component 642 may subtract the EVM limits from the UL SNR 620 to provide an expected effective SNR for a transmission, and the scheduler 710 may select the MCS 712 based on the expected effective SNR. The EVM limit component 642 may provide the EVM limits to the indication component 644. The EVM limit component 642 may provide the MCS 712 to the decoder 648. The EVM limit component 642 and/or the scheduler 710 may generate a DCI (e.g., DCI 614) indicating the MCS 712 and the resources 714.

The indication component 644 may receive the EVM limits from the EVM limit component 642. The indication component 644 may generate the EVM indication 612 based on the EVM limits. For example, the indication component 644 may generate an RRC configuration message to indicate the EVM limits. In another example, the indication component 644 may include the EVM limits in the DCI 614. The indication component 644 may transmit the EVM indication 612 via the transmitter component 652.

The decoder 648 may receive the uplink transmission 616 from the receiver component 650. The uplink transmission 616 may comply with the EVM limits indicated in the EVM indication 612. The decoder 648 may decode the uplink transmission 616. For example, the decoder 648 may use the DMRS and the PTRS to decode the PUCCH and PUSCH. The decoder 648 may extract the UCI from the PUCCH and provide the UCI to the EVM limit component 642. The decoder 648 may decode the PUSCH to determine transmitted data and provide the transmitted data to higher layers.

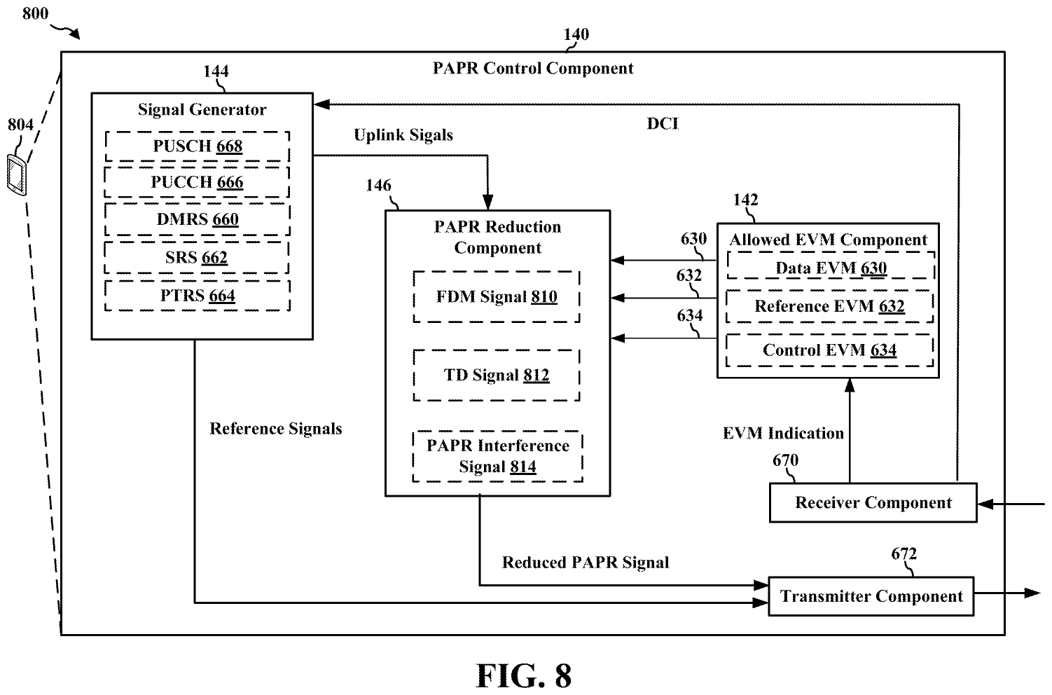

FIG. 8 is a conceptual data flow diagram 800 illustrating the data flow between different means/components in an example UE 804, which may be an example of the UE 104 and include the PAPR control component 140.

The receiver component 670 may receive the EVM indication 612 and/or the DCI 614. The receiver component 670 may provide the EVM indication 612 and/or the DCI 614 to the allowed EVM component 142, for example, where the DCI 614 carries the EVM indication 612. When the EVM indication 612 is separate from the DCI 614, the receiver component 670 may provide the EVM indication 612 to the allowed EVM component 142 and provide the DCI to the signal generator 144.

The allowed EVM component 142 may extract the EVM limits (e.g., the data EVM 630, the reference signal EVM 632, and the control EVM 634) from the EVM indication 612. The allowed EVM component 142 may provide the EVM limits to the PAPR reduction component 146.

The signal generator 144 may receive the DCI from the receiver component 670. As discussed above, the DCI may include the MCS 712 and the resources 714 for an uplink transmission. The signal generator 144 may generate one or more uplink signals based on the DCI 614. For example, the signal generator 144 may determine a size of a transport block based on the MCS 712 and the resources 714. The signal generator 144 may obtain transmission data from a buffer (e.g., a RLC layer buffer), code the transmission data, generate modulation symbols, and allocate the modulation symbols to the resources 714 for a data signal (e.g., PUSCH 668). The signal generator 144 may generate a control signal (e.g., PUCCH 666), for example, based on any ACK/NACK feedback and/or a buffer status and generate modulation symbols based on a MCS for the control channel. The signal generator 144 may also generate reference signals (e.g., DMRS 660, SRS 662, and PTRS 664) based on known sequences. The signal generator 144 may multiplex the uplink signals within the resources 714 using interleaving or block transmission as illustrated in FIG. 5. The signal generator 144 may provide the multiplexed uplink signals to the PAPR reduction component 146.

The PAPR reduction component 146 may perform PAPR reduction based on the EVM limits. For example, the PAPR reduction component 146 may apply one or more of: tone reservation, crest factor reduction (CFR), active constellation extension (ACE), or peak suppression with information message (PSIM) within the EVM limits for each signal. In another example, the PAPR reduction component 146 may apply the corresponding allowed EVM per signal of the one or more uplink signals. For instance, the PAPR reduction component 146 may apply the data EVM 630 to the PUSCH, apply the control EVM 634 to the PUCCH, and apply the reference signal EVM to the reference signals DMRS, PTRS, and SRS. In another example, the PAPR reduction component 146 may apply a smallest amount of allowed EVM per signal to a group of the one or more signals. For instance, the data EVM 630 may allow a smaller amount of EVM than the control EVM 534. Accordingly, when the one or more uplink signals includes PUSCH 668 and PUCCH 666, the PAPR reduction component 146 may apply the data EVM 630 to both the PUSCH 668 and the PUCCH 666. In another aspect, the PAPR reduction component 146 may apply an EVM limit per subcarrier based on a corresponding signal for each subcarrier. For instance, the PAPR reduction component 146 may generate a FDM signal 810, transform the FDM signal 810 to a time domain signal 812, and calculate a PAPR interference signal 814 based on the time domain signal 812. Details of one technique for applying an EVM limit per subcarrier are described in detail below with respect to FIG. 10. The PAPR reduction component 146 may provide the PAPR reduced signal 532 to the transmitter component 672 for transmission.

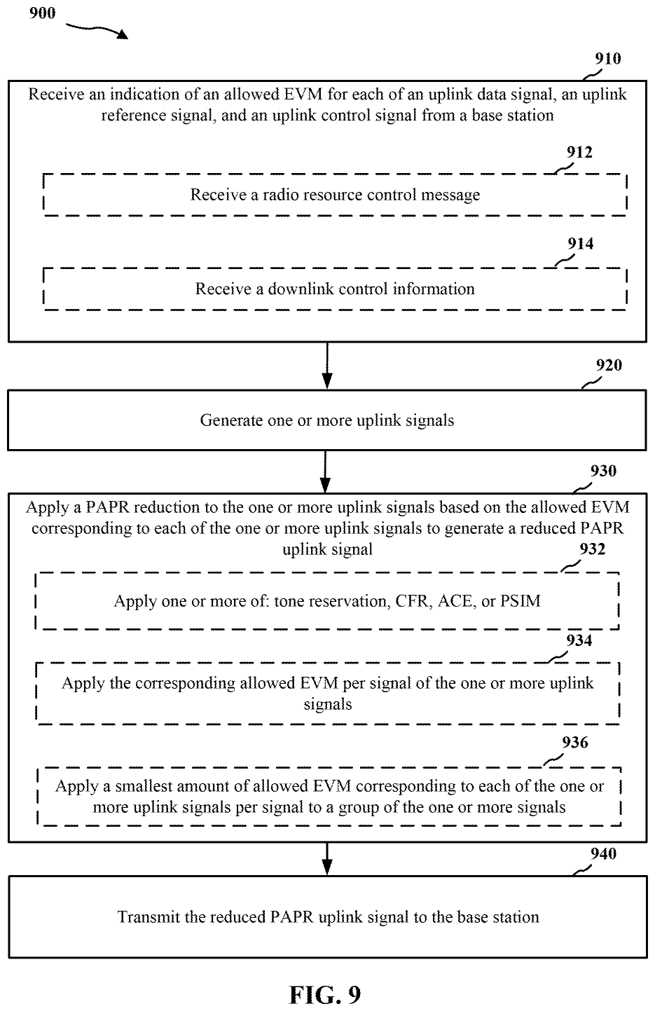

FIG. 9 is a flowchart of an example method 900 for transmitting a reduced PAPR uplink signal complying with EVM limits. The method 900 may be performed by a UE (such as the UE 104, which may include the memory 360 and which may be the entire UE 104 or a component of the UE 104 such as the PAPR control component 140, TX processor 368, the RX processor 356, or the controller/processor 359). The method 900 may be performed by the PAPR control component 140 in communication with the EVM control component 198 of the base station 102.

At block 910, the method 900 may include receiving an indication of an allowed EVM for each of an uplink data signal, an uplink reference signal, and an uplink control signal from a base station. In an aspect, for example, the UE 104, the RX processor 356, and/or the controller/processor 359 may execute the PAPR control component 140, the receiver component 670, and/or the allowed EVM component 142 to receive an indication (e.g., EVM indication 612) of an allowed EVM for each of an uplink data signal (e.g., data EVM 630), an uplink reference signal (e.g., reference signal EVM 632), and an uplink control signal (e.g., reference signal EVM 632) from a base station 102. For example, at sub-block 912 the block 910 may include receiving a radio resource control message. For instance, the radio resource control message may be carried on the PUSCH as a higher layer signal that is decoded. As another example, at sub-block 914, the block 910 may include receiving a downlink control information (DCI). For instance, the downlink control information may be carried on the PDCCH and interpreted at the PHY layer (e.g., along with MCS) to provide dynamic control of allowed EVM. Accordingly, the UE 104, the RX processor 356, and/or the controller/processor 359 executing the PAPR control component 140, the receiver component 670, and/or the allowed EVM component 142 may provide means for receiving an indication of an allowed EVM for each of an uplink data signal, an uplink reference signal, and an uplink control signal from a base station.

At block 920, the method 900 may include generating one or more uplink signals. In an aspect, for example, the UE 104, the TX processor 368, and/or the controller/processor 359 may execute the PAPR control component 140, and/or the signal generator 144 to generate one or more uplink signals. Accordingly, the UE 104, the TX processor 368, and/or the controller/processor 359 executing the PAPR control component 140, the receiver component 670, and/or the signal generator 144 may provide means for generating one or more uplink signals.

At block 930, the method 900 may include applying a PAPR reduction to the one or more uplink signals based on the allowed EVM corresponding to each of the one or more uplink signals to generate a reduced PAPR uplink signal. In an aspect, for example, the UE 104, the TX processor 368 and/or the controller/processor 359 may execute the PAPR control component 140 and/or the PAPR reduction component 146 to apply a PAPR reduction to the one or more uplink signals based on the allowed EVM corresponding to each of the one or more uplink signals to generate a reduced PAPR uplink signal. For example, at sub-block 932, the block 930 may optionally include applying one or more of: tone reservation, CFR, ACE, or PSIM. As another example, at sub-block 934, the block 930 may include applying the corresponding allowed EVM per signal of the one or more uplink signals. As another example, at sub-block 936, the block 930 may include applying a smallest amount of allowed EVM corresponding to each of the one or more uplink signals per signal to a group of the one or more signals. As another example, the block 930 may optionally include the method 1000 described below with respect to FIG. 10. Accordingly, the UE 104, the TX processor 368, and/or the controller/processor 359 executing the PAPR control component 140 and/or the PAPR reduction component 146 may provide means for applying a PAPR reduction to the one or more uplink signals based on the allowed EVM corresponding to each of the one or more uplink signals to generate a reduced PAPR uplink signal.

At block 940, the method 900 may include transmitting the reduced PAPR uplink signal to the base station. In an aspect, for example, the UE 104, the TX processor 368, and/or the controller/processor 359 may execute the PAPR control component 140, the transmitter component 672, and/or the transmission component 148 to transmit the reduced PAPR uplink signal the base station. Accordingly, the UE 104, the TX processor 368, and/or the controller/processor 359 executing the PAPR control component 140, the transmitter component 672, and/or the transmission component 148 may provide means for transmitting the reduced PAPR uplink signal to the base station.

FIG. 10 is a flowchart of an example method 1000 for applying a PAPR reduction based on per signal EVM limits. The method 1000 may be performed by a UE (such as the UE 104, which may include the memory 360 and which may be the entire UE 104 or a component of the UE 104 such as the PAPR control component 140, the PAPR reduction component 146, TX processor 368, the RX processor 356, or the controller/processor 359).

At block 1010, the method 1000 may include generating a FDM signal 810 including the one or more uplink signals. For example, the PAPR reduction component 146 may multiplex the one or more uplink signals in the frequency domain as illustrated in FIG. 5. The FDM signal 810 may be generated using a precoding matrix matching current channel conditions. For example the frequency domain signal (z) may be constructed according to z=Wx, where W is the precoding matrix, and x is the OFDM frequency-layer-domain data vector. More specifically, W may be a matrix (W_{PxB}) and x may be a vector (x_{Bxl}), where P is the number of transmission antennas and B is the number of layers.

At block 1020, the method 1000 may include generating a time domain signal 812 of the FDM signal 810. For example, the PAPR reduction component 146 may perform the IFFT 520. The frequency domain signal z_{pad} may be zero padded with the guard bands and signal over sampling. The interpolated time domain signal may be represented by the formula: a=ifft (Z_{pad})

At block 1030, the method 1000 may include calculating a PAPR interference signal 814 that when added to the time domain signal 812 reduces an overall PAPR of a combined signal. In an aspect, at sub-block 1032, the block 1030 may include clipping one or more peaks of the time domain signal 812 that are greater than a threshold to generate a clipped time domain signal. For instance, the clipped time domain signal may be represented by the formula â=clip {a}. At sub-block 1034, the block 1030 may include transforming the clipped time domain signal to the frequency domain to generate a clipped frequency domain signal. For example, the clipped frequency domain signal may be represented by the formula \hat{z}=fft{â}. At sub-block 1036, the block 1030 may include projecting a difference between the clipped frequency domain signal and the frequency domain multiplexed signal with weighting per sub-carrier over the frequency domain multiplexed signal. For example, the difference per sub-carrier (k) may be expressed as WΛₖW^{pinv}( [symbol] −zₖ), where zₖ is a P×1 column vector for subcarrier k (Tx antenna subcarrier vector), Λₖ is a diagonal weight matrix with Λ_{k,ii} representing the weight of interference on the i^{th} layer. Λₖ may be chosen based on a target EVM mapped to subcarrier k. That is, Λₖ may be selected based on the signal type and corresponding EVM limit of the subcarrier k. Accordingly, the PAPR interference signal may be represented as WΛₖW^{pinv}( [symbol] −zₖ).

In block 1040, the method 1000 may include applying a different PAPR interference signal per sub-carrier in the frequency domain depending on the allowed EVM corresponding to the uplink signal of each sub-carrier. For example, the uplink signal after applying the PAPR interference signal may be represented by the following formula:

zₖ^{next}=WΛₖW^{pinv}( [symbol] −zₖ)+zₖ.

In block 1050, the method 1000 may optionally include generating a next time domain signal based on the projecting. For example, the PAPR reduction component 146 may generate the next time domain signal by performing an IFFT 520 on the combined signal zₖ^{next}.

In block 1060, the method 1000 may optionally include repeating the clipping, transforming, and projecting on the next time domain signal until a target EVM is reached. For example, repeating block 1030 may further reduce the PAPR while the remaining within the EVM limit. The block 1030 may be repeated until a permitted convergence (e.g., EVM approaches EVM limit). Accordingly, the method 1000 may optimize PAPR reduction within the EVM limits for each type of signal.

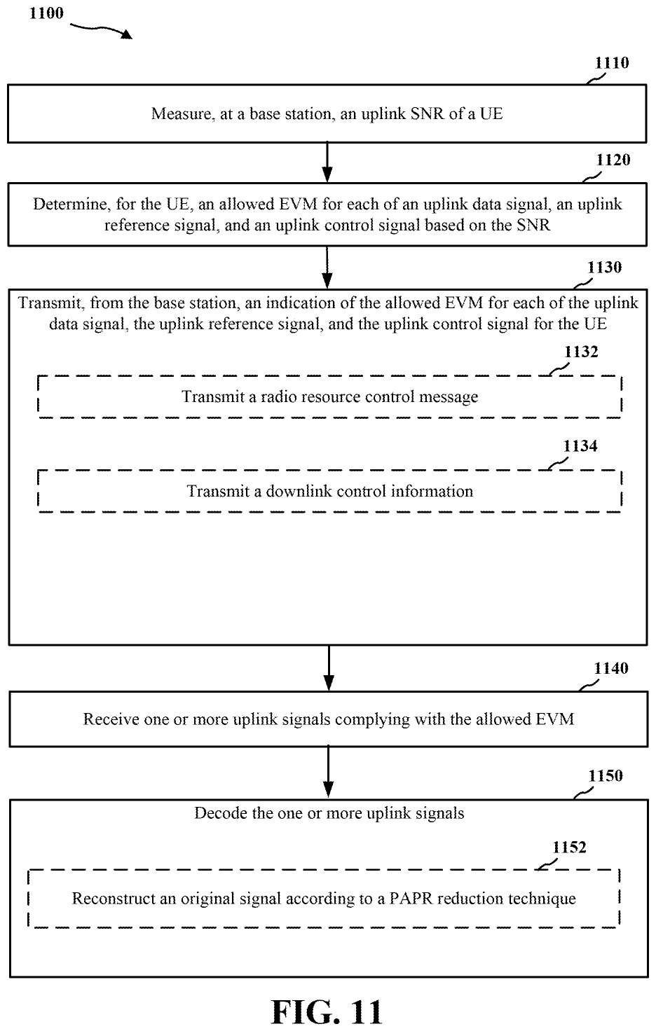

FIG. 11 is a flowchart of an example method 1100 for controlling EVM of uplink signals. The method 1100 may be performed by a base station (such as the base station 102, which may include the memory 376 and which may be the entire base station 102 or a component of the base station 102 such as the EVM control component 198, the TX processor 316, the RX processor 370, or the controller/processor 375). The method 1100 may be performed by the EVM control component 198 in communication with the PAPR control component 140 of the UE 104.

At block 1110, the method 1100 may include measuring an uplink SNR of a UE. In an aspect, for example, the base station 102, the controller/processor 375, and/or the RX processor 370 may execute the EVM control component 198, the measurement component 640, and/or the receiver component 650 to measure the uplink SNR of the UE 104. Accordingly, the base station 102, the controller/processor 375, and/or the RX processor 370 executing the EVM control component 198, the measurement component 640, and/or the receiver component 650 may provide means for measuring an uplink SNR of a UE.

At block 1120, the method 1100 may include determining, for the UE, an allowed EVM for each of an uplink data signal, an uplink reference signal, and an uplink control signal based on the SNR. In an aspect, for example, the base station 102, the controller/processor 375, and/or the RX processor 370 may execute the EVM control component 198 and/or the EVM limit component 642 to determine, for the UE 104, an allowed EVM for each of an uplink data signal (e.g., data EVM 630), an uplink reference signal (e.g., reference signal EVM 632), and an uplink control signal (e.g., control EVM 634) based on the UL SNR 620. Accordingly, the base station 102, the controller/processor 375, and/or the RX processor 370 executing the EVM control component 198, the measurement component 640, and/or the receiver component 650 may provide means for determining, for the UE, an allowed error vector magnitude (EVM) for each of an uplink data signal, an uplink reference signal, and an uplink control signal based on the SNR.

At block 1130, the method 1100 may include transmitting an indication of the allowed EVM for each of the uplink data signal, the uplink reference signal, and the uplink control signal for the UE. In an aspect, for example, the base station 102, the controller/processor 375, and/or the TX processor 316 may execute the EVM control component 198, the indication component 644 and/or the transmitter component 652 to transmit an indication of the allowed EVM (e.g., EVM indication 612) for each of the uplink data signal, the uplink reference signal, and the uplink control signal for the UE 104. For example, at sub-block 1132, the block 1130 may include transmitting a radio resource control message. As another example, at sub-block 1134, the block 1130 may include transmitting a downlink control information (e.g., DCI 614). For instance the DCI 614 may include both an MCS for the uplink transmission and the EVM indication 612 for the uplink transmission. Accordingly, the base station 102, the controller/processor 375, and/or the TX processor 316 executing the EVM control component 198, the indication component 644 and/or the transmitter component 652 may provide means for transmitting an indication of the allowed EVM for each of the uplink data signal, the uplink reference signal, and the uplink control signal for the UE.

At block 1140, the method 1100 may include receiving one or more uplink signals complying with the allowed EVM. In an aspect, for example, the base station 102, the controller/processor 375, and/or the RX processor 370 may execute the EVM control component 198 and/or the receiver component 650 to receive one or more uplink signals complying with the allowed EVM. Accordingly, the base station 102, the controller/processor 375, and/or the RX processor 370 executing the EVM control component 198 and/or the receiver component 650 may provide means for receiving one or more uplink signals complying with the allowed EVM.

At block 1150, the method 1100 may include decoding the one or more uplink signals. In an aspect, for example, the base station 102, the controller/processor 375, and/or the RX processor 370 may execute the EVM control component 198 and/or the decoder 648 to decode the one or more uplink signals. For example, in sub-block 1152, the block 1150 may include reconstructing an original signal according to a PAPR reduction technique. For example, when PSIM is used, the decoder 648 may decode the PSIM and reconstruct the original signal (e.g., FDM signal 510) by adding peak information to the received PUSCH. Accordingly, the base station 102, the controller/processor 375, and/or the RX processor 370 executing the EVM control component 198 and/or the decoder 648 may provide means for decoding the one or more uplink signals.

### Some Further Example Implementations

A first example method of wireless communication, comprising at a user equipment (UE): receiving an indication of an allowed error vector magnitude (EVM) for each of an uplink data signal, an uplink reference signal, and an uplink control signal from a base station; generating one or more uplink signals; applying a peak to average power ratio (PAPR) reduction to the one or more uplink signals based on the allowed EVM corresponding to each of the one or more uplink signals to generate a reduced PAPR uplink signal; and transmitting the reduced PAPR uplink signal to the base station.

The above first example method, wherein receiving the indication comprises receiving a radio resource control message.

Any of the above first example methods, wherein receiving the indication comprises receiving a downlink control information.

Any of the above first example methods, wherein applying the PAPR reduction to the one or more uplink signals comprises: generating a frequency domain multiplexed signal including the one or more uplink signals; generating a time domain signal of the frequency domain multiplexed signal; calculating a PAPR interference signal that when added to the time domain signal reduces an overall PAPR of a combined signal; and applying a different PAPR interference signal per sub-carrier in the frequency domain depending on the allowed EVM corresponding to the uplink signal of each sub-carrier.

Any of the above first example methods, wherein calculating the PAPR interference signal comprises: clipping one or more peaks of the time domain signal that are greater than a threshold to generate a clipped time domain signal; transforming the clipped time domain signal to the frequency domain to generate a clipped frequency domain signal; and projecting a difference between the clipped frequency domain signal and the frequency domain multiplexed signal with weighting per sub-carrier over the frequency domain multiplexed signal.

Any of the above first example methods, further comprising: generating a next time domain signal based on the projecting; and repeating the clipping, transforming, and projecting on the next time domain signal until a target EVM is reached.

Any of the above first example methods, wherein applying the PAPR reduction comprises applying one or more of: tone reservation, crest factor reduction (CFR), active constellation extension (ACE), or peak suppression with information message (PSIM).

Any of the above first example methods, wherein applying the PAPR reduction to the one or more uplink signals comprises applying the corresponding allowed EVM per signal of the one or more uplink signals.

Any of the above first example methods, wherein applying the PAPR reduction to the one or more uplink signals comprises applying a smallest amount of allowed EVM corresponding to each of the one or more uplink signals per signal to a group of the one or more signals.

A second example method of wireless communication, comprising, at a base station: measuring an uplink signal to noise ratio (SNR) of a user equipment (UE); determining, for the UE, an allowed error vector magnitude (EVM) for each of an uplink data signal, an uplink reference signal, and an uplink control signal based on the SNR; transmitting an indication of the allowed EVM for each of the uplink data signal, the uplink reference signal, and the uplink control signal for the UE; receiving one or more uplink signals complying with the allowed EVM; and decoding the one or more uplink signals.

The above second example method, wherein transmitting the indication comprises transmitting a radio resource control message.

Any of the above second example methods, wherein transmitting the indication comprises transmitting a downlink control information scheduling the one or more uplink signals.

Any of the above second example methods, wherein determining, for the UE, the allowed EVM for each of the uplink data signal, the uplink reference signal, and the uplink control signal for the UE based on the SNR comprises determining a difference between a measured SNR for a respective signal and a required SNR for a modulation and coding scheme (MCS) of the signal for a scheduled transmission.

Any of the above second example methods, wherein decoding the one or more uplink signals comprises decoding the one or more uplink signals based on a PAPR reduction technique.

A first example apparatus for wireless communication, comprising: a memory storing computer-executable instructions; and at least one processor coupled to the memory and configured to execute the computer-executable instructions to: receive an indication of an allowed error vector magnitude (EVM) for each of an uplink data signal, an uplink reference signal, and an uplink control signal from a base station; generate one or more uplink signals; apply a peak to average power ratio (PAPR) reduction to the one or more uplink signals based on the allowed EVM corresponding to each of the one or more uplink signals; and transmit the one or more uplink signals to the base station.

The above first example apparatus, wherein the at least one processor is configured to receive the indication as a radio resource control message.

Any of the above first example apparatuses, wherein the at least one processor is configured to receive the indication as a downlink control information.

Any of the above first example apparatuses, wherein the at least one processor is configured to: generate a frequency domain multiplexed signal including the one or more uplink signals; generate a time domain signal of the frequency domain multiplexed signal; calculate a PAPR interference signal that when added to the time domain signal reduces an overall PAPR of a combined signal; and apply a different PAPR interference signal per sub-carrier in the frequency domain depending on the allowed EVM corresponding to the uplink signal of each sub-carrier.

Any of the above first example apparatuses, wherein the at least one processor is configured to: clip one or more peaks of the time domain signal that are greater than a threshold to generate a clipped time domain signal; transform the clipped time domain signal to the frequency domain to generate a clipped frequency domain signal; and project a difference between the clipped frequency domain signal and the frequency domain multiplexed signal with weighting per sub-carrier over the frequency domain multiplexed signal.

Any of the above first example apparatuses, wherein the at least one processor is configured to: generate a next time domain signal based on the projecting; and repeat the clipping, transforming, and projecting on the next time domain signal until a target EVM is reached.

Any of the above first example apparatuses, wherein the at least one processor is configured to apply one or more of: tone reservation, crest factor reduction (CFR), active constellation extension (ACE), or peak suppression with information message (PSIM).

Any of the above first example apparatuses, wherein the at least one processor is configured to apply the corresponding allowed EVM per signal of the one or more uplink signals.

Any of the above first example apparatuses, wherein the at least one processor is configured to apply a smallest amount of allowed EVM corresponding to each of the one or more uplink signals per signal to a group of the one or more signals.

A second example apparatus for wireless communication, comprising: a memory storing computer-executable instructions; and at least one processor coupled to the memory and configured to execute the computer-executable instructions to: measure an uplink signal to noise ratio (SNR) of a user equipment (UE); determine, for the UE, an allowed error vector magnitude (EVM) for each of an uplink data signal, an uplink reference signal, and an uplink control signal based on the SNR; transmit an indication of the allowed EVM for each of the uplink data signal, the uplink reference signal, and the uplink control signal for the UE; receive one or more uplink signals complying with the allowed EVM; and decode the one or more uplink signals.

The above second example apparatus, wherein the at least one processor is configured to transmit the indication as a radio resource control message.

Any of the above second example apparatuses, wherein the at least one processor is configured to transmit the indication as a downlink control information scheduling the one or more uplink signals.

Any of the above second example apparatuses, wherein the at least one processor is configured to determine, for the UE, the allowed EVM for each of the uplink data signal, the uplink reference signal, and the uplink control signal based on the SNR by determining a difference between a measured SNR for a respective signal and a required SNR for a modulation and coding scheme (MCS) of the signal for a scheduled transmission.

Any of the above second example apparatuses, wherein the at least one processor is configured to decode the one or more uplink signals based on a PAPR reduction technique.

A third example apparatus for wireless communications, comprising: means for performing any of the above first example methods.

A first example non-transitory computer-readable medium storing computer-executable instructions to perform any of the above first example methods.

A fourth example apparatus for wireless communications, comprising: means for performing any of the above second example methods.

A second example non-transitory computer-readable medium storing computer-executable instructions to perform any of the above second example methods.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication, comprising, at a user equipment (UE):
receiving an indication of an allowed error vector magnitude (EVM) for each of an uplink data signal, an uplink reference signal, and an uplink control signal from a base station;
generating one or more uplink signals;
applying a peak to average power ratio (PAPR) reduction to the one or more uplink signals based on the allowed EVM corresponding to each of the one or more uplink signals to generate a reduced PAPR uplink signal; and
transmitting the reduced PAPR uplink signal to the base station.

2. The method of claim 1, wherein receiving the indication comprises receiving a radio resource control message.

3. The method of claim 1, wherein receiving the indication comprises receiving a downlink control information.

4. The method of claim 1, wherein applying the PAPR reduction to the one or more uplink signals comprises:
generating a frequency domain multiplexed signal including the one or more uplink signals;
generating a time domain signal of the frequency domain multiplexed signal;
calculating a PAPR interference signal that when added to the time domain signal reduces an overall PAPR of a combined signal; and
applying a different PAPR interference signal per sub-carrier in the frequency domain depending on the allowed EVM corresponding to the uplink signal of each sub-carrier.

5. The method of claim 4, wherein calculating the PAPR interference signal comprises:
clipping one or more peaks of the time domain signal that are greater than a threshold to generate a clipped time domain signal;
transforming the clipped time domain signal to the frequency domain to generate a clipped frequency domain signal; and
projecting a difference between the clipped frequency domain signal and the frequency domain multiplexed signal with weighting per sub-carrier over the frequency domain multiplexed signal.

6. The method of claim 5, further comprising:
generating a next time domain signal based on the projecting; and
repeating the clipping, transforming, and projecting on the next time domain signal until a target EVM is reached.

7. The method of claim 1, wherein applying the PAPR reduction comprises applying one or more of: tone reservation, crest factor reduction (CFR), active constellation extension (ACE), or peak suppression with information message (PSIM).

8. The method of claim 1, wherein applying the PAPR reduction to the one or more uplink signals comprises applying the corresponding allowed EVM per signal of the one or more uplink signals.

9. The method of claim 1, wherein applying the PAPR reduction to the one or more uplink signals comprises applying a smallest amount of allowed EVM corresponding to each of the one or more uplink signals per signal to a group of the one or more uplink signals.

10. A method of wireless communication, comprising, at a base station:
measuring an uplink signal to noise ratio (SNR) of a user equipment (UE);
determining, for the UE, an allowed error vector magnitude (EVM) for each of an uplink data signal, an uplink reference signal, and an uplink control signal based on the SNR;
transmitting an indication of the allowed EVM for each of the uplink data signal, the uplink reference signal, and the uplink control signal for the UE;
receiving one or more uplink signals complying with the allowed EVM; and
decoding the one or more uplink signals.

11. The method of claim 10, wherein transmitting the indication comprises transmitting a radio resource control message.

12. The method of claim 10, wherein transmitting the indication comprises transmitting a downlink control information scheduling the one or more uplink signals.

13. The method of claim 10, wherein determining, for the UE, the allowed EVM for each of the uplink data signal, the uplink reference signal, and the uplink control signal for the UE based on the SNR comprises determining a difference between a measured SNR for a respective signal and a required SNR for a modulation and coding scheme (MCS) of the signal for a scheduled transmission.

14. The method of claim 10, wherein decoding the one or more uplink signals comprises decoding the one or more uplink signals based on a PAPR reduction technique.

15. An apparatus for wireless communication, comprising:
a memory storing computer-executable instructions; and
at least one processor coupled to the memory and configured to execute the computer-executable instructions to:
receive an indication of an allowed error vector magnitude (EVM) for each of an uplink data signal, an uplink reference signal, and an uplink control signal from a base station;
generate one or more uplink signals;
apply a peak to average power ratio (PAPR) reduction to the one or more uplink signals based on the allowed EVM corresponding to each of the one or more uplink signals; and
transmit the one or more uplink signals to the base station.

16. The apparatus of claim 15, wherein the at least one processor is configured to receive the indication as a radio resource control message.

17. The apparatus of claim 15, wherein the at least one processor is configured to receive the indication as a downlink control information.

18. The apparatus of claim 15, wherein the at least one processor is configured to:
generate a frequency domain multiplexed signal including the one or more uplink signals;
generate a time domain signal of the frequency domain multiplexed signal;
calculate a PAPR interference signal that when added to the time domain signal reduces an overall PAPR of a combined signal; and
apply a different PAPR interference signal per sub-carrier in the frequency domain depending on the allowed EVM corresponding to the uplink signal of each sub-carrier.

19. The apparatus of claim 18, wherein the at least one processor is configured to:
clip one or more peaks of the time domain signal that are greater than a threshold to generate a clipped time domain signal;
transform the clipped time domain signal to the frequency domain to generate a clipped frequency domain signal; and
project a difference between the clipped frequency domain signal and the frequency domain multiplexed signal with weighting per sub-carrier over the frequency domain multiplexed signal.

20. The apparatus of claim 19, wherein the at least one processor is configured to:
generate a next time domain signal based on the projecting; and
repeat the clipping, transforming, and projecting on the next time domain signal until a target EVM is reached.

21. The apparatus of claim 15, wherein the at least one processor is configured to apply one or more of: tone reservation, crest factor reduction (CFR), active constellation extension (ACE), or peak suppression with information message (PSIM).

22. The apparatus of claim 15, wherein the at least one processor is configured to apply the corresponding allowed EVM per signal of the one or more uplink signals.

23. The apparatus of claim 15, wherein the at least one processor is configured to apply a smallest amount of allowed EVM corresponding to each of the one or more uplink signals per signal to a group of the one or more uplink signals.

24. An apparatus for wireless communication, comprising:
a memory storing computer-executable instructions; and
at least one processor coupled to the memory and configured to execute the computer-executable instructions to:
measure an uplink signal to noise ratio (SNR) of a user equipment (UE);
determine, for the UE, an allowed error vector magnitude (EVM) for each of an uplink data signal, an uplink reference signal, and an uplink control signal based on the SNR;
transmit an indication of the allowed EVM for each of the uplink data signal, the uplink reference signal, and the uplink control signal for the UE;
receive one or more uplink signals complying with the allowed EVM; and
decode the one or more uplink signals.

25. The apparatus of claim 24, wherein the at least one processor is configured to transmit the indication as a radio resource control message.

26. The apparatus of claim 24, wherein the at least one processor is configured to transmit the indication as a downlink control information scheduling the one or more uplink signals.

27. The apparatus of claim 24, wherein the at least one processor is configured to determine, for the UE, the allowed EVM for each of the uplink data signal, the uplink reference signal, and the uplink control signal based on the SNR by determining a difference between a measured SNR for a respective signal and a required SNR for a modulation and coding scheme (MCS) of the signal for a scheduled transmission.

28. The apparatus of claim 24, wherein the at least one processor is configured to decode the one or more uplink signals based on a PAPR reduction technique.
